(19) United States
(12) Patent Application Publication
(10) Pub. No.: US 2009/0078117 A1
(43) Pub. Date: Mar. 26, 2009

(54) Filter Element and Arrangement

(75) Inventors: Karl Julch, Laudenbach (DE); Thomas Schroth, Bobenheim (DE); Eckhart Driesen, Heidelberg (DE); Samuel Rivera, Clarksville, TN (US)

Correspondence Address: Davidson, Davidson & Kappel, LLC, 485 7th Avenue, 14th Floor, New York, NY, 10018, US

(73) Assignee: Carl Freudenberg KG, Weinheim (DE)

(21) Appl. No.: 11/922,636

(22) PCT Filed: Apr. 22, 2006
(86) PCT No.: PCT/EP2006/003727

§ 371 Date: Dec. 20, 2007

Related U.S. Application Data
(60) Provisional application No. 60/740,315, filed on Nov. 29, 2005.

(30) Foreign Application Priority Data
Jun. 27, 2005 (DE) 10 2005 030 024.3

(51) Int. Cl. B01D 46/06; B01D 53/04

(52) U.S. Cl. 96/154; 55/489

(57) ABSTRACT

The invention pertains to a filter element that includes a first flat layer and a second flat layer, wherein the layers are connected to one another such that a volume and an opening are formed, wherein the layers are spaced apart from one another via spacing devices arranged between the layers (1, 2), and wherein the spacing devices connect both layers to one another. With respect to the objective of disclosing a filter arrangement that can be easily manufactured and ensures a flawless operation, the invention proposes that such a filter element is characterized in that the spacing devices are regionally connected to one of the layers only. The invention also discloses an arrangement comprising a filter element and a frame.

### TECHNICAL FIELD

The invention pertains to a filter element comprising a first flat layer and a second flat layer, wherein the layers are connected to one another such that a volume and an opening are formed, wherein the layers are spaced apart from one another by means arranged between the layers, and wherein the means connect both layers to one another. The invention furthermore pertains to an arrangement that comprises a filter element and a frame.

### STATE OF THE ART

Such filter elements and arrangements are already known from the state of the art. These filter elements are used as pocket filters in air-conditioning and ventilation systems. These pocket filters feature means for spacing apart the layers and for preventing these layers from adjoining one another and negatively influencing the filtering effect. These means are usually realized in a strip-shaped fashion, wherein both layers are connected by a seam and feature a slot in the region of the opening of the pocket filter in order to widen the pocket filter in the region of the opening.

Due to these measures, the filter element can be widened in the region of the opening while it is tapered toward the opposite end of the filter element referred to the opening. This ensures that an air current is able to penetrate into a wedge-shaped filter element over a large surface in order to be filtered.

In filter elements of the initially cited type, it is disadvantageous, however, that the arrangement of the slots in the means requires an additional production step such that the costs for the manufacture of such pocket filters are significantly increased. It is also disadvantageous that the length of the slots needs to be realized uniformly in all means. This additionally complicates the manufacture of such filter elements. Another problem can be seen in that the slots may tear during the operation and during the manufacture such that their length is changed in an undesirable fashion. This can result in extremely disadvantageous effects on the flow conditions within the filter element.

### DISCLOSURE OF THE INVENTION

The invention is based on the objective of disclosing a filter arrangement that can be easily manufactured and ensures a flawless operation.

According to the present invention, the aforementioned objective is attained with the characteristics of Claim 1. Therefore, a filter element of the initially cited type is characterized in that the means are regionally connected to one of the layers only.

According to the invention, it was recognized that the slots can be effectively eliminated if the means are regionally connected to one of two layers only. Due to these measures, it is advantageously possible to space apart the layers from one another and to easily widen the opening. In this case, the opening can be widened in such a way that the distance defined by the width of the means is exceeded. The design according to the invention eliminates the subsequent processing step for producing a slot. Damages to the means due to the undesirable tearing of a slot are also prevented. The invention therefore makes it possible to realize a filter arrangement that can be easily manufactured and ensures a flawless operation.

Consequently, the initially cited objective is attained.

In one embodiment that is particularly advantageous with respect to constructive considerations, the means may be connected to one layer only in the region of the opening. This allows a particularly unproblematic manufacture of the filter element because the connection between the means and the layer needs to be interrupted on one side of the filter element only.

In another embodiment, the means may be alternately connected to one of the respective layers in the region of the opening. In this case, it would be conceivable, in particular, that several parallel means are alternately assigned to either only the first layer or only the second layer in the region of opening. In such an embodiment, the first means is connected to the first layer only in the region of the opening and the adjacent means is connected to the second layer only in the region of the opening. This concrete embodiment ensures that adjacent means do not unfavorably reduce the size of the opening, for example, due to the means adhering to one another or becoming intertwisted. Due to the alternating arrangement, the loose regions of the means are arranged on opposite sides such that it is nearly impossible for the means to come in contact with one another. A free passage for an air current to be filtered is always provided in this fashion.

The means may be realized in the form of flat elements. The utilization of flat elements allows an unproblematic manufacture and the formation of defined air flow channels within the filter elements. The realization of channels makes it possible to guide an air current to be filtered in a directed and non-turbulent fashion.

In this context, the means may be realized in the form of strips. The design of the means in the form of strips makes it possible to realize a defined spacing between the two flat layers as well as an unproblematic preproduction of the means.

The means may be realized in a U-shaped fashion, wherein one respective limb of the U is connected to one of the layers. In this case, it would be conceivable, in particular, that a first limb of the U is connected to one of the layers over its entire length while the other limb of the U is not connected to the opposite layer along a defined section in the region of the filter element opening. The utilization of a U-shaped means makes it possible to fix the means to the layers to be spaced apart in a particularly stable fashion, namely because one seam or several seams can be easily produced on one limb in order to permanently connect the means to the layers. Since the means are solidly fixed to the layers, the filter element is also able to withstand the strongest air currents.

The layers may be manufactured of formed fabrics. In this case, it would be conceivable that the formed fabrics consist of staple fibers, nanofibers, microfibers or electrostatically charged fibers. The utilization of a formed fabric makes it possible to achieve very good filtering capacities because a formed fabric can be adapted to different requirements due to its adjustable porosity.

The means may also be manufactured of formed fabrics. This specific design ensures that the filter element is manufactured of a uniform material. In addition, it is ensured that the air current encounters the largest surface possible in order to filter contaminants out of the air current.

In this context, it would be conceivable that the formed fabric comprises activated charcoal or activated charcoals granulate or that one or more layers comprising activated charcoal or activated charcoal granulate is/are assigned to the formed fabric. This specific embodiment makes it possible to filter unpleasant odors out of the air current. This embodiment is particularly well suited for use in air-conditioning systems of buildings, ships or automobiles because the quality of the atmospheric environment is subject to particularly strict requirements in these applications.

The layers may have a rectangular shape and be connected to one another on three sides. This embodiment ensures a particularly simple design of the filter element. This embodiment also makes it possible to realize a bag-like, wedge-shaped structure, in which an air current can be captured in order to be filtered.

The layers and/or the means may be connected to one another by ultrasonic welding. This specific embodiment makes it possible to connect formed fabrics to one another in a particularly solid fashion. In addition, a seam produced by ultrasonic welding is usually characterized in that it has an increased material density and thusly provides the filter element with certain stability. A seam produced by ultrasonic welding also ensures that the region of the seam is particularly gas-tight. In dependence on the desired stability only, it would be possible to produce several seams in order to regionally increase the stability of the filter element. In this case, it would be conceivable, in particular, that the seams produced by ultrasonic welding act as support elements.

In this context, the layers and/or the means may also be connected to one another by laser welding. A laser welding process is characterized in that the seams can be produced in a particularly fast and exact fashion. In addition, a laser welding process makes it possible to realize punctiform connections between different parts of the filter element.

The initially cited objective is also attained with the characteristics of Claim 13.

In order to avoid repetitions, we refer to the embodiments of the filter element as such with respect to the inventive activity.

The frame and the filter element may be inseparably connected to one another. This makes it possible to realize a stable arrangement. In this context, the filter element could be cast or foamed into the frame or the filter element and the frame may be realized in one piece.

At least one seal may be assigned to the supporting structure. If a seal is provided at the manufacturing facility, no additional assembly steps are required during the installation of the frame into a holding arrangement. The arrangement of a seal on the frame at the manufacturing facility therefore eliminates assembly steps such as, for example, bonding the seal to the frame and aligning the seal in a precisely fitted fashion.

The supporting structure and the seal may be realized in one piece. In this case, it would be conceivable that the seal is realized in the form of a tapered region of the supporting structure. The seal could be realized, in particular, in the form of a sealing lip that can be easily deformed and pressed against a surface due to its material thickness. This specific embodiment makes it possible to manufacture the supporting structure of a uniform material and ensures a particularly tight seal because boundary surfaces between the seal and the supporting structure can be eliminated.

At least one seal could be positively connected to the supporting structure. Such a positive connection makes it possible to fix the seal in position without having to utilize an adhesive. If the supporting structure features a seal receptacle, the installer is able to easily and exactly arrange the seal in the position defined for ensuring an optimal tightness.

In this context, the supporting structure could feature a recess for pressing in the seal. The recess could be realized in the form of a rectangular groove or a dovetail-shaped groove. In this case, a massive compressible seal could be pressed into the groove in such a way that it is positively connected to the supporting structure.

The supporting structure could consist of at least one foamed material. This specific embodiment makes it possible to foam a filter element into the supporting structure and to simultaneously finish the supporting structure. This ensures a particularly tight seal between the supporting structure and the filter element. Polyurethane is an inexpensive material that can be easily processed and therefore is quite suitable as the material for the foaming process.

The supporting structure could consist of at least one injection-moulded material. In this case, it would be conceivable that the supporting structure consists of two components that are injection-moulded to one another. The supporting structure could consist of a more rigid material and a seal that is integrally injection-moulded to the supporting structure could consist of a softer material. In this case, the supporting structure could consist of polyamide and the seal injection-moulded thereon could consist of a thermoplastic elastomer. Another advantage of this embodiment can be seen in that the supporting structure and the filter element can be integrally connected to one another such that the seal between the supporting structure and the filter element is particularly tight.

The supporting structure could consist of a formed fabric. In this case, it would be conceivable that the formed fabric is structurally stabilized by means of a thermal treatment in such a way that it has the rigidity required for effectively fixing a filter element in a holding arrangement. This specific embodiment makes it possible to manufacture an arrangement consisting of a frame and a filter element of a uniform material. In this context, it would also be conceivable, in particular, that several filter elements are arranged adjacent to one another and pressed together by means of a thermal treatment in such a way that a supporting structure is defined by the regions of their adjoining openings.

The frame could comprise a supporting structure that has a rectangular shape. This specific embodiment allows a checkerboard-like arrangement of several supporting structures in a so-called filter house, in which supporting structures with filter elements are arranged adjacent to and on top of one another in several rows and columns. The supporting structures usually have a square shape.

The supporting structure could comprise braces. In this case, it would be conceivable, in particular, that the braces and the supporting structure are realized in one piece, namely in the form of a screen. The braces advantageously make it possible to connect the supporting structure to the flat layers of the filter element. The braces also ensure that several filter elements can be arranged adjacent to one another, wherein the filter elements are fixed by the connection between the braces and the flat layers.

All embodiments of the supporting structure described in connection with the arrangement could conceivably also be utilized in connection with an insulated frame that comprises such a supporting structure. In this respect, the invention also discloses a frame as such that may comprise a supporting structure according to one of the described embodiments independently of the arrangement and the filter element.

The characteristics of the present invention can be advantageously realized and additionally developed in different ways. In this respect, we refer to the dependent claims on one hand and to the following description of preferred embodiments of the inventive filter element and arrangement on the other hand. Generally preferred realizations and additional developments of the invention are also discussed in connection with the description of the preferred embodiments that refers to the figures.

### BRIEF DESCRIPTION OF THE FIGURES

The figures show:

FIG. 1, a filter element in the form of a schematic projection;

FIG. 2, a filter element with alternately arranged means;

FIG. 3, an arrangement with a frame and a filter element;

FIG. 4, a supporting structure with two assigned seals;

FIG. 5, a supporting structure with an assigned U-shaped seal, and

FIG. 6, a supporting structure with a recess for receiving a seal.

### DISCLOSURE OF THE INVENTION

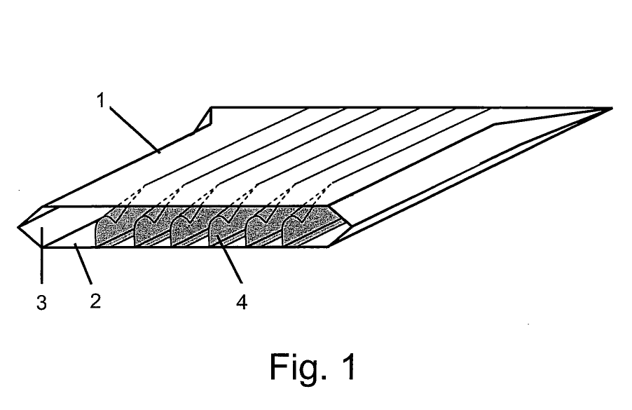

FIG. 1 shows a filter element comprising a first flat layer 1 and a second flat layer 2, wherein the layers 1, 2 are connected to one another such that a volume and an opening 3 are formed, and wherein the layers 1, 2 are spaced apart from one another by means 4 arranged between the layers 1, 2. The means 4 connect both layers 1, 2 to one another. The means 4 are regionally connected to one of the layers 1, 2 only.

The means 4 are connected to one layer 1 only in the region of the opening 3.

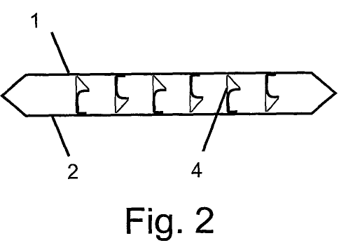

FIG. 2 shows a top view of the opening 3, wherein the means 4 are alternately connected to one of the respective layers 1, 2 in the region of the opening 3.

The means 4 are designed in the form of flat elements. They are realized in a U-shaped fashion, wherein one respective limb of the U is connected to one of the layers 1, 2.

The layers 1, 2 as well as the means 4 are manufactured of a formed fabric.

The layers 1, 2 have a rectangular shape and are connected to one another on three sides.

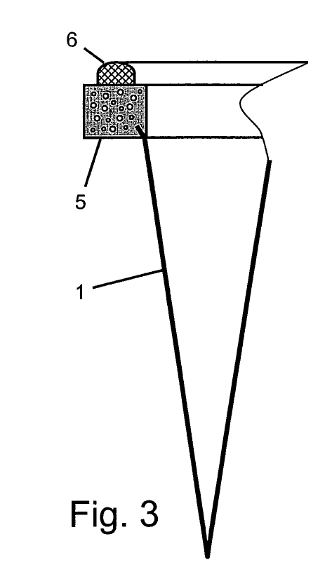

FIG. 3 shows an arrangement with a frame that serves for accommodating a filter element and comprises a supporting structure 5. A seal 6 is assigned to the supporting structure.

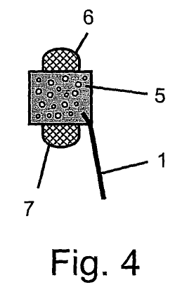

FIG. 4 shows the frame 5 with a seal 6 and a seal 7 that are arranged on opposite sides of the frame. It would also be conceivable that only the seal 6 or 7 is arranged on one of the sides of the supporting structure 5 or that seals are provided on three sides of the supporting structure 5.

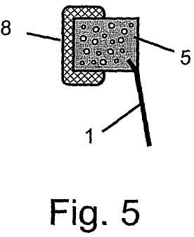

FIG. 5 shows a U-shaped seal 8 that adjoins the supporting structure on three sides.

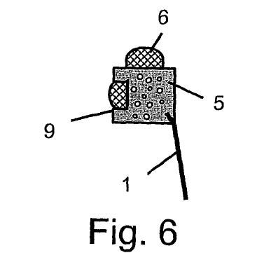

FIG. 6 shows the supporting structure with a recess 9. The recess 9 has a rectangular shape and serves for positively accommodating a seal.

With respect to other advantageous realizations and additional developments of the invention, we refer to the general portion of the description on one hand and to the attached claims on the other hand.

In conclusion, it should be particularly emphasized that the randomly chosen embodiments described above merely serve for explaining the invention, and that the invention is not limited to these embodiments.

1-26. (canceled)

27. A filter element comprising a first flat layer and a second flat layer, wherein the layers are connected to one another such that a volume and an opening are formed, wherein the layers are spaced apart from one another by means arranged between the layers, and wherein the means connect both layers to one another, wherein the means are regionally connected to one of the layers only.

28. The filter element as recited in claim 27, wherein the means are connected to one layer only in the region of the opening.

29. The filter element as recited in claim 28, wherein the means are alternately connected to one of the layers in the region of the opening.

30. The filter element as recited in claim 27, wherein the means are realized in the form of flat elements.

31. The filter element as recited in claim 30, wherein the means are realized in the form of strips.

32. The filter element as recited in claim 30, wherein the means are realized in a U-shaped fashion, wherein one respective limb of the U is connected to one of the layers.

33. The filter element as recited in claim 27, wherein the layers are manufactured of a formed fabric.

34. The filter element as recited in claim 27, wherein the means are manufactured of a formed fabric.

35. The filter element as recited in claim 33, wherein the formed fabric comprises activated charcoal or activated charcoal granulate.

36. The filter element as recited in claim 27, wherein the layers have a rectangular shape and are connected to one another on three sides.

37. The filter element as recited in claim 27, wherein the layers and/or the means are connected to one another by ultrasonic welding.

38. The filter element as recited in claim 27, wherein the layers and/or the means are connected to one another by laser welding.

39. An arrangement comprising a filter element as recited in claim 27 and a frame with a supporting structure.

40. The arrangement as recited in claim 39, wherein the frame and the filter element are inseparably connected to one another.

41. The arrangement as recited in claim 39, wherein the filter element is cast or foamed into the frame.

42. The arrangement as recited in claim 39, wherein the frame and the filter element are realized in one piece.

43. The arrangement as recited in claim 39, wherein at least one seal is assigned to the supporting structure.

44. The arrangement as recited in claim 43, wherein the supporting structure and the seal are realized in one piece.

45. The arrangement as recited in claim 44, wherein the seal is realized in the form of a tapered region of the supporting structure.

46. The arrangement as recited in claim 39, wherein at least one seal can be positively connected to the supporting structure.

47. The arrangement as recited in claim 39, wherein the supporting structure features a recess for pressing in a seal.

48. The arrangement as recited in claim 39, wherein the supporting structure consists of at least one foamed material.

49. The arrangement as recited in claim 39, wherein the supporting structure consists of at least one injection-moulded material.

50. The arrangement as recited in claim 39, wherein the supporting structure consists of a formed fabric.

51. The arrangement as recited in claim 39, wherein the supporting structure has a rectangular shape.

52. The arrangement as recited in claim 39, wherein the supporting structure comprises braces.
